(19) United States
(12) Patent Application Publication
(10) Pub. No.: US 2026/0214235 A1
(43) Pub. Date: Jul. 23, 2026

(54) GPM COMBINATION WITH INTER TOOLS

(71) Applicant: InterDigital CE Patent Holdings, SAS, Paris (FR)

(72) Inventors: Kevin Reuzé, Rennes (FR); Karam Naser, Mouazé (FR); Antoine Robert, Mézières sur Couesnon (FR); Franck Galpin, Thorigne-Fouillard (FR); Ya Chen, Rennes (FR)

(73) Assignee: InterDigital CE Patent Holdings, SAS, Paris (FR)

(21) Appl. No.: 19/142,323

(22) PCT Filed: Dec. 20, 2023
(86) PCT No.: PCT/EP2023/087126

§ 371 Date: Jun. 23, 2025

(30) Foreign Application Priority Data
Dec. 23, 2022 (EP) 22307026.9

(51) Int. Cl. H04N 19/137; H04N 19/119; H04N 19/176

(52) U.S. Cl. CPC H04N 19/137; H04N 19/119; H04N 19/176

(57) ABSTRACT

A video device may employ bi-directional prediction in Geometric Partition Mode (GPM). A video device, which may be a video encoding and/or video decoding device, may determine, for a coding block, a first geometric partitioning mode (GPM) partition and a second GPM partition. The video device may obtain, for the coding block, a motion information merge candidate list comprising at least one bi-prediction motion information. The video device may determine, for the first GPM partition, first bi-predicted motion information, based on the motion information merge candidate list, and may predict the first GPM partition based on the first bi-prediction motion information. The video device may determine, for the second GPM partition, second bi-predicted motion information, based on the motion information merge candidate list, and may predict the second GPM partition based on the second bi-predicted motion information.

### CROSS-REFERENCE TO RELATED APPLICATIONS

This application claims the benefit of European Patent Application Number 22307026.9, filed Dec. 23, 2022, the contents of which are hereby incorporated by reference herein in their entirety.

### BACKGROUND

Video coding systems may be used to compress digital video signals, e.g., to reduce the storage and/or transmission bandwidth needed for such signals. Video coding systems may include, for example, block-based, wavelet-based, and/or object-based systems.

### SUMMARY

Systems, methods, and instrumentalities are disclosed for combining Geometric Partition Mode (GPM) with other coding technologies including, for example, bi-directional prediction, Decoder Side Motion-vector Refinement (DMVR), Multiple Hypothesis Prediction (MHP), and affine merge mode.

Systems, methods, and instrumentalities are disclosed for employing bi-directional prediction in Geometric Partition Mode (GPM). A video device, which may be a video encoding and/or video decoding device, may be configured to determine, for a coding block, a first geometric partitioning mode (GPM) partition and a second GPM partition. The video device may be configured to obtain, for the coding block, a motion information merge candidate list comprising at least one bi-prediction motion information. The motion information merge candidate list may comprise an extended merge candidate list. The video device may be configured to decode and/or encode the coding block based on the motion information merge candidate list comprising the at least one bi-prediction motion information.

The video device may be configured to determine, for the first GPM partition, first bi-predicted motion information, based on the motion information merge candidate list, and to predict the first GPM partition based on the first bi-prediction motion information. The video device may be further configured to determine, for the second GPM partition, second bi-predicted motion information, based on the motion information merge candidate list, and to predict the second GPM partition based on the second bi-predicted motion information.

The video device may be configured to receive a first indication, e.g. a first flag, indicating the motion information merge candidate list is associated with the first GPM partition, and to receive a second indication, e.g., second flag, indicating a uni-prediction candidate list is associated with the second GPM partition. The video device may be configured to obtain, for the coding block, the uni-prediction candidate list. The video device may determine, for the second GPM partition, uni-predicted motion information, based on the uni-prediction candidate list, and predict the second GPM partition based on the uni-predicted motion information.

The video device may be further configured to determine, for a second coding block, a third GPM partition and a fourth GPM partition. The video device may obtain, for the third GPM partition, a first affine motion model and may perform affine motion compensation prediction on the third GPM partition based on the first affine motion model. The first affine motion model may use a uni-prediction candidate as a Control Point Motion Vector and/or may use a bi-prediction candidate as a Control Point Motion Vector. The video device may perform affine motion compensation prediction by determining a first set of control points associated with the first GPM partition and determining a first set of motion vectors using affine motion compensation prediction based on at least the first set of control points. The video device may obtain, for the fourth GPM partition, a second affine motion model, and may perform affine motion compensation prediction on the fourth GPM partition based on the second affine motion model.

The video device, if configured to determine, for the first GPM partition, the first bi-predicted motion information, may be further configured to refine the first bi-predicted motion information using decoder side motion vector refinement (DMVR)

The video device, if configured to determine, for the first GPM partition, the first bi-predicted motion information, may be further configured to determine the first bi-predicted motion information using multiple hypothesis prediction (MHP). The video device, if configured to determine, for the second GPM partition, the second bi-predicted motion information may be further configured to determine the second bi-predicted motion information using multiple hypothesis prediction (MHP).

Systems, methods, and instrumentalities are disclosed for employing bi-directional prediction in Geometric Partition Mode. A device, which may be, for example, an encoder, may determine for a coding unit a first geometric partitioning mode (GPM) partition and a second GPM partition. A first prediction mode may be associated with the first GPM partition and a second prediction mode may be associated with the second GPM partition. For example, the first GPM partition may employ inter prediction and the second GPM partition may employ intra prediction. The device may determine bi-directional motion vectors for at least one of the first GPM partition and the second GPM partition. Bi-directional motion vectors may be determined for both GPM partitions and/or for one GPM partition. The device may determine for each of the first GPM partition and the second GPM partition, a flag that indicates whether bi-directional motion vectors have been determined for the particular one of the GPM partitions. The device may encode the coding unit including the at least one of the first GPM partition and the second GPM partition based on the determined bi-directional motion vectors. The flags may be encoded and communicated with the encoded coding unit to the decoder. The decoder may use the flags to implement bi-directional prediction in Geometric Partition Mode.

Systems, methods, and instrumentalities are disclosed for employing Decoder Side Motion Refinement (DMVR) in Geometric Partition Mode. A device, which may be, for example, a decoder, may determine for a coding unit a first geometric partitioning mode (GPM) partition, a second GPM partition, and a third GPM partition. The third GPM partition may be positioned between the first GPM partition and the second GPM partition. A first prediction mode may be associated with the first GPM partition and a second prediction mode may be associated with the second GPM partition. For example, the first GPM partition may employ inter prediction and the second GPM partition may employ intra prediction. The device may apply bilateral matching (BM) to at least one of the first GPM partition, the second GPM partition, and the third GPM partition to refine a motion vector. The device may decode the at least one of the first GPM partition, the second GPM partition, and the third GPM partition based on the refined motion vector. The device may apply bilateral matching to each of the first, second, and third GPM partitions and may decode the first, second, and third GPM partitions based on the motion vector. The device may apply bilateral matching to the third GPM partition and may decode the first, second, and third GPM partitions based on the motion vector. The device may apply bilateral matching to the third GPM partition and may decode only the third GPM partition based on the motion vector.

Systems, methods, and instrumentalities are disclosed for employing Multiple Hypothesis Prediction (MHP) in Geometric Partition Mode. A device, which may be, for example, an encoder, may determine for a coding unit a first geometric partitioning mode (GPM) partition and a second GPM partition. A first prediction mode may be associated with the first GPM partition and a second prediction mode may be associated with the second GPM partition. For example, the first GPM partition may employ inter prediction and the second GPM partition may employ intra prediction. The device may determine a directional prediction signal and may determine at least one additional motion-compensated prediction signal associated with multi-hypothesis prediction (MHP). If the first prediction method is bi-directional prediction and the second prediction method is uni-directional prediction, the device may determine one additional motion-compensated prediction signal. If the first prediction method is uni-directional and the second prediction method is uni-directional, the device may determine two additional motion-compensated prediction signals. If the first prediction method is uni-directional prediction and the second prediction method is intra prediction, the device may determine two additional motion-compensated prediction signals. The device may encode the coding unit using the at least the motion-compensated prediction signal and may send the encoded coding unit and the at least one additional motion-compensated prediction signal to the decoder.

Systems, methods, and instrumentalities are disclosed for employing affine merge mode in Geometric Partition Mode. A device, which may be, for example, an encoder, may determine for a coding unit a first geometric partitioning mode (GPM) partition and a second GPM partition. The device may determine for the first GPM partition a first motion vector using affine transform motion compensation prediction. The device may determine for the second GPM partition a second motion vector using affine transform motion compensation. The device may determine a first set of control points associated with the first GPM partition and may determine a second set of control points associated with the second GPM partition. The device may determine the first motion vector using affine transform motion compensation prediction and the second motion vector using affine transform motion compensation based on the first set of control points and the second set of control points. The device may encode the coding unit using the first motion vector and the second motion vector.

Systems, methods, and instrumentalities described herein may involve a decoder. In some examples, the systems, methods, and instrumentalities described herein may involve an encoder. In some examples, the systems, methods, and instrumentalities described herein may involve a signal (e.g., from an encoder and/or received by a decoder). A computer-readable medium may include instructions for causing one or more processors to perform methods described herein. A computer program product may include instructions which, when the program is executed by one or more processors, may cause the one or more processors to carry out the methods described herein.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example video encoder.

FIG. 3 illustrates an example video decoder.

FIG. 4 illustrates an example of a system in which various aspects and examples may be implemented.

FIG. 5 depicts an example geometric split description.

FIG. 6 depicts an example geometric partition.

FIG. 7 depicts example angles for GEO with corresponding width to height ratio.

FIG. 8 depicts an example uni-prediction MV selection for GEO partition mode.

FIG. 9 depicts an example GPM with inter and intra prediction.

FIG. 10 depicts an example edge on a template.

FIG. 11 depicts an example of diamond regions in a search area.

FIG. 12 depicts an example control point based affine motion model.

FIG. 13 depicts example affine MVF per subblock.

FIG. 14 depicts an example GPM split boundary.

FIG. 15 depicts example control points for use depending on partition angle.

### DETAILED DESCRIPTION

A more detailed understanding may be had from the following description, given by way of example in conjunction with the accompanying drawings.

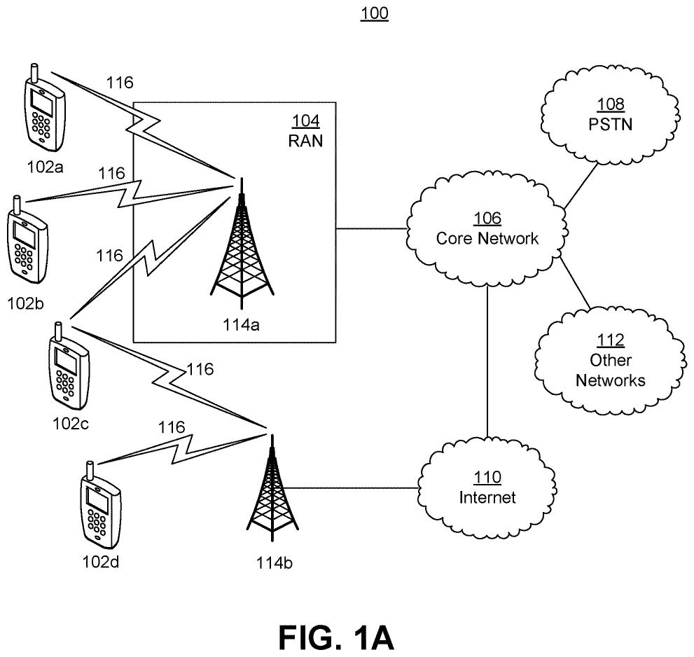

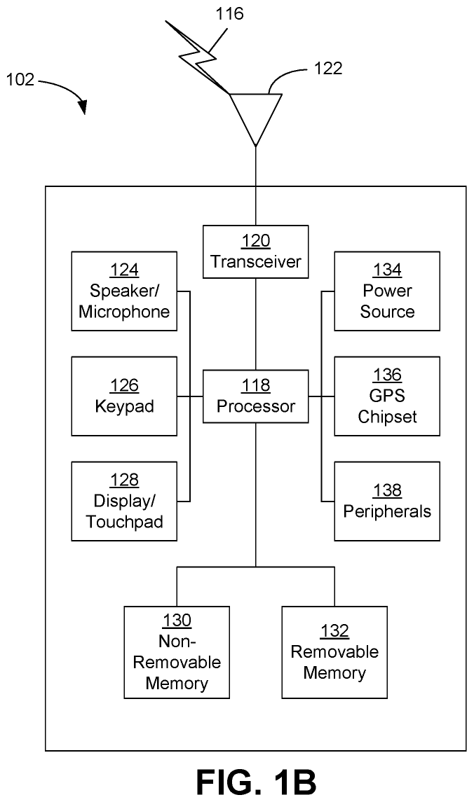

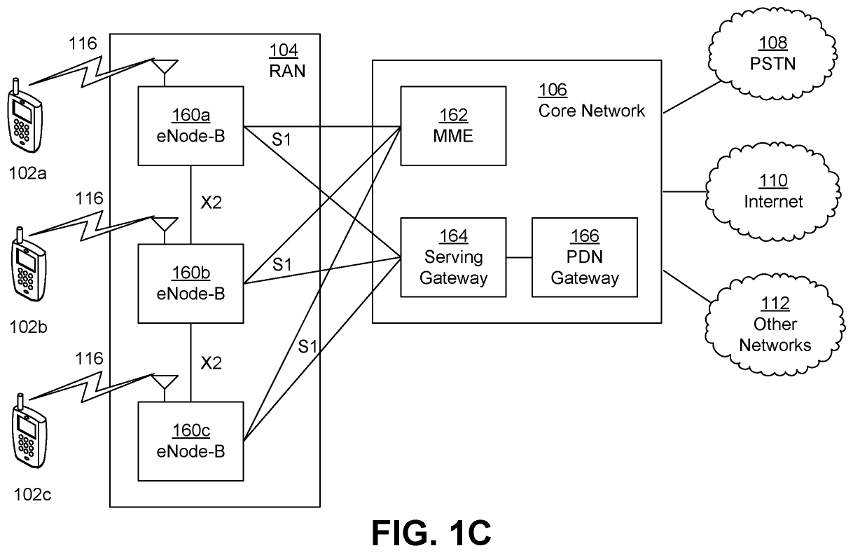

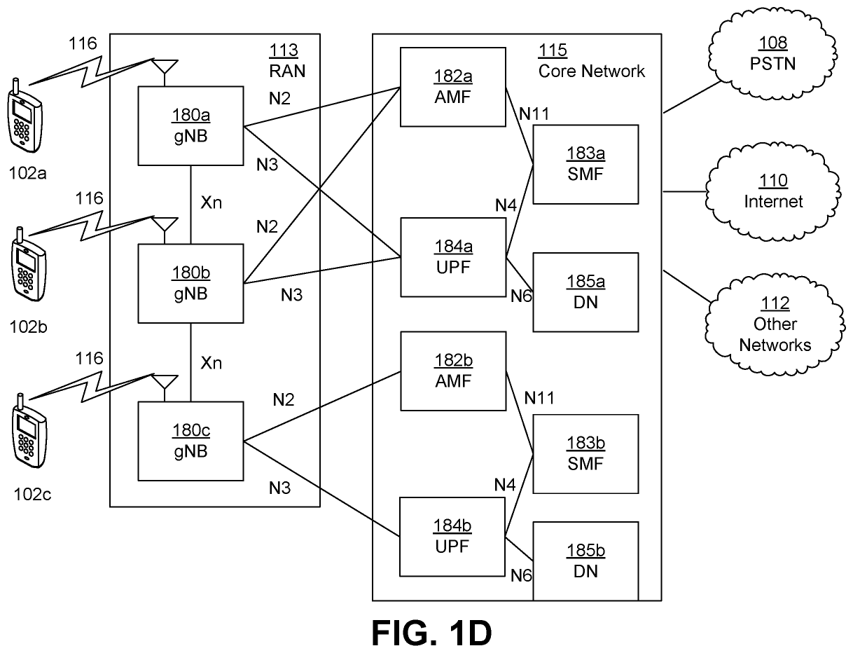

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example, in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHz, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

This application describes a variety of aspects, including tools, features, examples, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects may be combined and interchanged to provide further aspects. Moreover, the aspects may be combined and interchanged with aspects described in earlier filings as well.

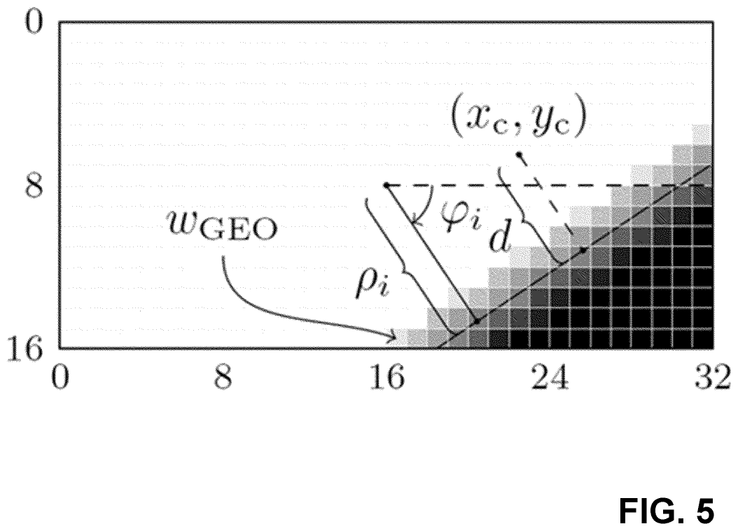

The aspects described and contemplated in this application may be implemented in many different forms. FIGS. 5-15 described herein may provide some examples, but other examples are contemplated. The discussion of FIGS. 5-15 does not limit the breadth of the implementations. At least one of the aspects generally relates to video encoding and decoding, and at least one other aspect generally relates to transmitting a bitstream generated or encoded. These and other aspects may be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various examples to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

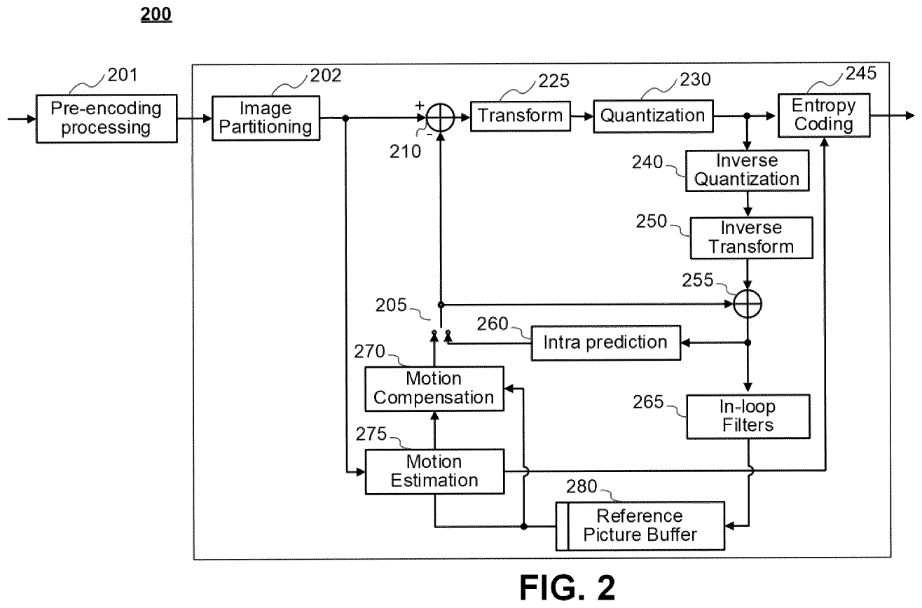

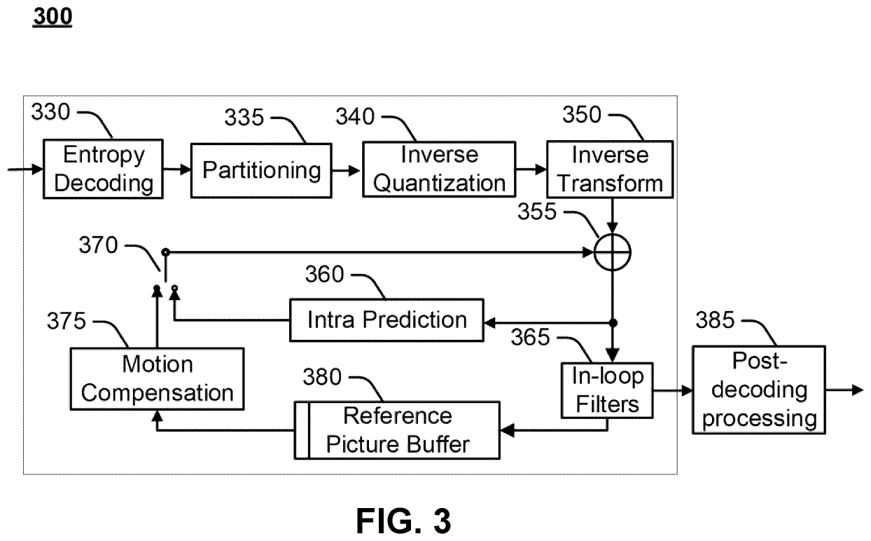

Various methods and other aspects described in this application may be used to modify modules, for example, decoding modules, of a video encoder 200 and decoder 300 as shown in FIG. 2 and FIG. 3. Moreover, the subject matter disclosed herein may be applied, for example, to any type, format or version of video coding, whether described in a standard or a recommendation, whether pre-existing or future-developed, and extensions of any such standards and recommendations. Unless indicated otherwise, or technically precluded, the aspects described in this application may be used individually or in combination.

Various numeric values are used in examples described the present application, such as motion vector calculations, partition angles, etc. These and other specific values are for the purpose of describing examples and the aspects described are not limited to these specific values.

FIG. 2 is a diagram showing an example video encoder. Variations of example encoder 200 are contemplated, but the encoder 200 is described below for purposes of clarity without describing all expected variations.

Before being encoded, the video sequence may go through pre-encoding processing (201), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata may be associated with the pre-processing and attached to the bitstream.

In the encoder 200, a picture is encoded by the encoder elements as described below. The picture to be encoded is partitioned (202) and processed in units of, for example, coding units (CUs). Each unit is encoded using, for example, either an intra or inter mode. When a unit is encoded in an intra mode, it performs intra prediction (260). In an inter mode, motion estimation (275) and compensation (270) are performed. The encoder decides (205) which one of the intra mode or inter mode to use for encoding the unit, and indicates the intra/inter decision by, for example, a prediction mode flag. Prediction residuals are calculated, for example, by subtracting (210) the predicted block from the original image block.

The prediction residuals are then transformed (225) and quantized (230). The quantized transform coefficients, as well as motion vectors and other syntax elements, are entropy coded (245) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (240), and inverse transformed (250) to decode prediction residuals. Combining (255) the decoded prediction residuals and the predicted block, an image block is reconstructed. In-loop filters (265) are applied to the reconstructed picture to perform, for example, deblocking/SAO (Sample Adaptive Offset) filtering to reduce encoding artifacts. The filtered image is stored at a reference picture buffer (280).

FIG. 3 is a diagram showing an example of a video decoder. In example decoder 300, a bitstream is decoded by the decoder elements as described below. Video decoder 300 generally performs a decoding pass reciprocal to the encoding pass as described in FIG. 2. The encoder 200 also generally performs video decoding as part of encoding video data.

In particular, the input of the decoder includes a video bitstream, which may be generated by video encoder 200. The bitstream is first entropy decoded (330) to obtain transform coefficients, motion vectors, and other coded information. The picture partition information indicates how the picture is partitioned. The decoder may therefore divide (335) the picture according to the decoded picture partitioning information. The transform coefficients are de-quantized (340), and inverse transformed (350) to decode the prediction residuals. Combining (355) the decoded prediction residuals and the predicted block, an image block is reconstructed. The predicted block may be obtained (370) from intra prediction (360) or motion-compensated prediction (i.e., inter prediction) (375). In-loop filters (365) are applied to the reconstructed image. The filtered image is stored at a reference picture buffer (380).

The decoded picture can further go through post-decoding processing (385), for example, an inverse color transform (e.g., conversion from YCbCr 4:2:0 to RGB 4:4:4) or an inverse remapping performing the inverse of the remapping process performed in the pre-encoding processing (201). The post-decoding processing can use metadata derived in the pre-encoding processing and signaled in the bitstream. In an example, the decoded images (e.g., after application of the in-loop filters (365) and/or after post-decoding processing (385), if post-decoding processing is used) may be sent to a display device for rendering to a user.

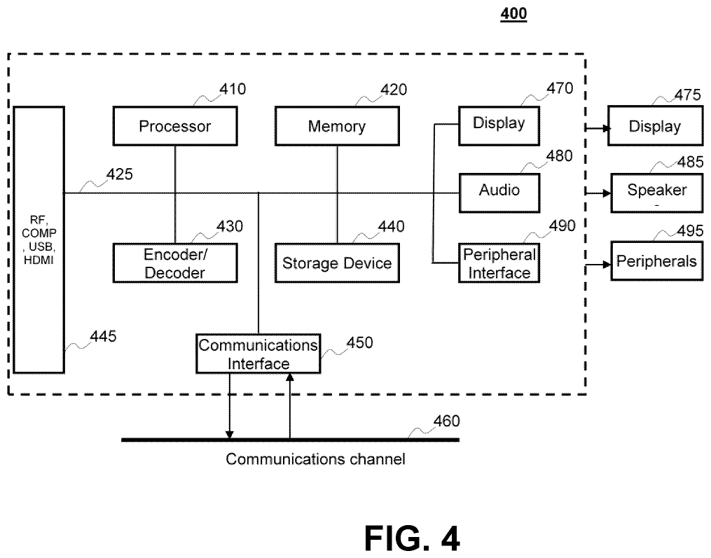

FIG. 4 is a diagram showing an example of a system in which various aspects and examples described herein may be implemented. System 400 may be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 400, singly or in combination, may be embodied in a single integrated circuit (IC), multiple ICs, and/or discrete components. For example, in at least one example, the processing and encoder/decoder elements of system 400 are distributed across multiple ICs and/or discrete components. In various examples, the system 400 is communicatively coupled to one or more other systems, or other electronic devices, via, for example, a communications bus or through dedicated input and/or output ports. In various examples, the system 400 is configured to implement one or more of the aspects described in this document.

The system 400 includes at least one processor 410 configured to execute instructions loaded therein for implementing, for example, the various aspects described in this document. Processor 410 can include embedded memory, input output interface, and various other circuitries as known in the art. The system 400 includes at least one memory 420 (e.g., a volatile memory device, and/or a non-volatile memory device). System 400 includes a storage device 440, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 440 can include an internal storage device, an attached storage device (including detachable and non-detachable storage devices), and/or a network accessible storage device, as non-limiting examples.

System 400 includes an encoder/decoder module 430 configured, for example, to process data to provide an encoded video or decoded video, and the encoder/decoder module 430 can include its own processor and memory. The encoder/decoder module 430 represents module(s) that may be included in a device to perform the encoding and/or decoding functions. As is known, a device can include one or both of the encoding and decoding modules. Additionally, encoder/decoder module 430 may be implemented as a separate element of system 400 or may be incorporated within processor 410 as a combination of hardware and software as known to those skilled in the art.

Program code to be loaded onto processor 410 or encoder/decoder 430 to perform the various aspects described in this document may be stored in storage device 440 and subsequently loaded onto memory 420 for execution by processor 410. In accordance with various examples, one or more of processor 410, memory 420, storage device 440, and encoder/decoder module 430 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some examples, memory inside of the processor 410 and/or the encoder/decoder module 430 is used to store instructions and to provide working memory for processing that is needed during encoding or decoding. In other examples, however, a memory external to the processing device (for example, the processing device may be either the processor 410 or the encoder/decoder module 430) is used for one or more of these functions. The external memory may be the memory 420 and/or the storage device 440, for example, a dynamic volatile memory and/or a non-volatile flash memory. In several examples, an external non-volatile flash memory is used to store the operating system of, for example, a television. In at least one example, a fast external dynamic volatile memory such as a RAM is used as working memory for video encoding and decoding operations.

The input to the elements of system 400 may be provided through various input devices as indicated in block 445. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High-Definition Multimedia Interface (HDMI) input terminal. Other examples, not shown in FIG. 4, include composite video.

In various examples, the input devices of block 445 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which may be referred to as a channel in certain examples, (iv) demodulating the down converted and band-limited signal, (v) performing error correction, and/or (vi) demultiplexing to select the desired stream of data packets. The RF portion of various examples includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, down converting the received signal to a lower frequency (for example, an intermediate frequency or a near-baseband frequency) or to baseband. In one set-top box example, the RF portion and its associated input processing element receives an RF signal transmitted over a wired (for example, cable) medium, and performs frequency selection by filtering, down converting, and filtering again to a desired frequency band. Various examples rearrange the order of the above-described (and other) elements, remove some of these elements, and/or add other elements performing similar or different functions. Adding elements can include inserting elements in between existing elements, such as, for example, inserting amplifiers and an analog-to-digital converter. In various examples, the RF portion includes an antenna.

The USB and/or HDMI terminals can include respective interface processors for connecting system 400 to other electronic devices across USB and/or HDMI connections. It is to be understood that various aspects of input processing, for example, Reed-Solomon error correction, may be implemented, for example, within a separate input processing IC or within processor 410 as necessary. Similarly, aspects of USB or HDMI interface processing may be implemented within separate interface ICs or within processor 410 as necessary. The demodulated, error corrected, and demultiplexed stream is provided to various processing elements, including, for example, processor 410, and encoder/decoder 430 operating in combination with the memory and storage elements to process the data stream as necessary for presentation on an output device.

Various elements of system 400 may be provided within an integrated housing, Within the integrated housing, the various elements may be interconnected and transmit data therebetween using suitable connection arrangement 425, for example, an internal bus as known in the art, including the Inter-IC (12C) bus, wiring, and printed circuit boards.

The system 400 includes communication interface 450 that enables communication with other devices via communication channel 460. The communication interface 450 can include, but is not limited to, a transceiver configured to transmit and to receive data over communication channel 460. The communication interface 450 can include, but is not limited to, a modem or network card and the communication channel 460 may be implemented, for example, within a wired and/or a wireless medium.

Data is streamed, or otherwise provided, to the system 400, in various examples, using a wireless network such as a Wi-Fi network, for example IEEE 802.11 (IEEE refers to the Institute of Electrical and Electronics Engineers). The Wi-Fi signal of these examples is received over the communications channel 460 and the communications interface 450 which are adapted for Wi-Fi communications. The communications channel 460 of these examples is typically connected to an access point or router that provides access to external networks including the Internet for allowing streaming applications and other over-the-top communications. Other examples provide streamed data to the system 400 using a set-top box that delivers the data over the HDMI connection of the input block 445. Still other examples provide streamed data to the system 400 using the RF connection of the input block 445. As indicated above, various examples provide data in a non-streaming manner. Additionally, various examples use wireless networks other than Wi-Fi, for example a cellular network or a Bluetooth® network.

The system 400 can provide an output signal to various output devices, including a display 475, speakers 485, and other peripheral devices 495. The display 475 of various examples includes one or more of, for example, a touchscreen display, an organic light-emitting diode (OLED) display, a curved display, and/or a foldable display. The display 475 may be for a television, a tablet, a laptop, a cell phone (mobile phone), or other device. The display 475 can also be integrated with other components (for example, as in a smart phone), or separate (for example, an external monitor for a laptop). The other peripheral devices 495 include, in various examples, one or more of a stand-alone digital video disc (or digital versatile disc) (DVD, for both terms), a disk player, a stereo system, and/or a lighting system. Various examples use one or more peripheral devices 495 that provide a function based on the output of the system 400. For example, a disk player performs the function of playing the output of the system 400.

In various examples, control signals are communicated between the system 400 and the display 475, speakers 485, or other peripheral devices 495 using signaling such as AV.Link, Consumer Electronics Control (CEC), or other communications protocols that enable device-to-device control with or without user intervention. The output devices may be communicatively coupled to system 400 via dedicated connections through respective interfaces 470, 480, and 490. Alternatively, the output devices may be connected to system 400 using the communications channel 460 via the communications interface 450. The display 475 and speakers 485 may be integrated in a single unit with the other components of system 400 in an electronic device such as, for example, a television. In various examples, the display interface 470 includes a display driver, such as, for example, a timing controller (T Con) chip.

The display 475 and speakers 485 can alternatively be separate from one or more of the other components, for example, if the RF portion of input 445 is part of a separate set-top box. In various examples in which the display 475 and speakers 485 are external components, the output signal may be provided via dedicated output connections, including, for example, HDMI ports, USB ports, or COMP outputs.

The examples may be carried out by computer software implemented by the processor 410 or by hardware, or by a combination of hardware and software. As a non-limiting example, the examples may be implemented by one or more integrated circuits. The memory 420 may be of any type appropriate to the technical environment and may be implemented using any appropriate data storage technology, such as optical memory devices, magnetic memory devices, semiconductor-based memory devices, fixed memory, and removable memory, as non-limiting examples. The processor 410 may be of any type appropriate to the technical environment, and can encompass one or more of microprocessors, general purpose computers, special purpose computers, and processors based on a multi-core architecture, as non-limiting examples.

Various implementations involve decoding. “Decoding”, as used in this application, can encompass all or part of the processes performed, for example, on a received encoded sequence in order to produce a final output suitable for display. In various examples, such processes include one or more of the processes typically performed by a decoder, for example, entropy decoding, inverse quantization, inverse transformation, and differential decoding. In various examples, such processes also, or alternatively, include processes performed by a decoder of various implementations described in this application, for example, attendant to performing GPM in combination with bi-prediction, Multiple Hypothesis Prediction (MHP), Decoder Side Motion Refinement (DMVR), and/or affine merge mode, etc.

As further examples, in one example “decoding” refers only to entropy decoding, in another example “decoding” refers only to differential decoding, and in another example “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various examples, such processes include one or more of the processes typically performed by an encoder, for example, partitioning, differential encoding, transformation, quantization, and entropy encoding. In various examples, such processes also, or alternatively, include processes performed by an encoder of various implementations described in this application, for example, to perform GPM in combination with bi-prediction, Multiple Hypothesis Prediction (MHP), Decoder Side Motion Refinement (DMVR), and/or affine merge mode etc.

As further examples, in one example “encoding” refers only to entropy encoding, in another example “encoding” refers only to differential encoding, and in another example “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that syntax elements as used herein are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein may be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus may be implemented in, for example, appropriate hardware, software, and firmware. The methods may be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one example” or “an example” or “one implementation” or “an implementation”, as well as other variations thereof, means that a particular feature, structure, characteristic, and so forth described in connection with the example is included in at least one example. Thus, the appearances of the phrase “in one example” or “in an example” or “in one implementation” or “in an implementation”, as well any other variations, appearing in various places throughout this application are not necessarily all referring to the same example.

Additionally, this application may refer to “determining” various pieces of information. Determining the information can include one or more of, for example, estimating the information, calculating the information, predicting the information, or retrieving the information from memory. Obtaining may include receiving, retrieving, constructing, generating, and/or determining.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. Encoder signals may include, for example, any attendant to performing GPM in combination with bi-prediction, Multiple Hypothesis Prediction (MHP), Decoder Side Motion Refinement (DMVR), and/or affine merge mode. In this way, in an example the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling may be used without transmitting (implicit signaling) to simply allow the decoder to know and select the particular parameter. By avoiding transmission of any actual functions, a bit savings is realized in various examples. It is to be appreciated that signaling may be accomplished in a variety of ways. For example, one or more syntax elements, flags, and so forth are used to signal information to a corresponding decoder in various examples. While the preceding relates to the verb form of the word “signal”, the word “signal” can also be used herein as a noun.

As will be evident to one of ordinary skill in the art, implementations may produce a variety of signals formatted to carry information that may be, for example, stored or transmitted. The information can include, for example, instructions for performing a method, or data produced by one of the described implementations. For example, a signal may be formatted to carry the bitstream of a described example. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on, or accessed or received from, a processor-readable medium.

Many examples are described herein. Features of examples may be provided alone or in any combination, across various claim categories and types. Further, examples may include one or more of the features, devices, or aspects described herein, alone or in any combination, across various claim categories and types. For example, features described herein may be implemented in a bitstream or signal that includes information generated as described herein. The information may allow a decoder to decode a bitstream, the encoder, bitstream, and/or decoder according to any of the embodiments described. For example, features described herein may be implemented by creating and/or transmitting and/or receiving and/or decoding a bitstream or signal. For example, features described herein may be implemented a method, process, apparatus, medium storing instructions, medium storing data, or signal. For example, features described herein may be implemented by a TV, set-top box, cell phone, tablet, or other electronic device that performs decoding. The TV, set-top box, cell phone, tablet, or other electronic device may display (e.g., using a monitor, screen, or other type of display) a resulting image (e.g., an image from residual reconstruction of the video bitstream). The TV, set-top box, cell phone, tablet, or other electronic device may receive a signal including an encoded image and perform decoding.

Systems, methods, and instrumentalities are disclosed for employing bi-directional prediction in Geometric Partition Mode (GPM). A video device, which may be a video decoding and/or video encoding device, may determine, for a coding block, a first geometric partitioning mode (GPM) partition and a second GPM partition. The video device may obtain, for the coding block, a motion information merge candidate list comprising at least one bi-prediction motion information. The video device may be configured to decode and/or encode the coding block based on the motion information merge candidate list comprising the at least one bi-prediction motion information. The video device may determine, for the first GPM partition, first bi-predicted motion information, based on the motion information merge candidate list, and may predict the first GPM partition based on the first bi-prediction motion information. The video device may determine, for the second GPM partition, second bi-predicted motion information, based on the motion information merge candidate list, and may predict the second GPM partition based on the second bi-predicted motion information.

Systems, methods, and instrumentalities are disclosed for combining Geometric Partition Mode (GPM) with other coding technologies. A device may determine bi-directional motion vectors for a first GPM partition and a second GPM partition and may encode a coding unit based on the bi-directional motion vectors. A device may apply bilateral matching to at least one of a first, second, or third GPM partition to refine a motion vector using Decoder Side Motion-vector Refinement (DMVR) and may decode the at least one GPM partition using the refined motion vector. A device may determine a directional prediction signal and may determine at least one additional motion-compensated prediction signal associated with Multiple Hypothesis Prediction (MHP). The number of additional motion-compensated prediction signals generated may be determined based on prediction modes associated with the GPM partitions. The device may encode the coding unit using the at least one additional motion-compensated prediction signal. A device may determine a first motion vector using affine transform motion compensation prediction for a first GPM partition and may determine a second motion vector using affine transform motion compensation for a second GPM partition. The device may encode the coding unit comprising the first and second GPM partitions using the first and second motion vectors.

Geometric merge mode (GEO), which may also be referred to as Geometric Partition Mode (GPM), may be provided. Both the acronyms GEO and GPM may be used interchangeably to refer to the geometric merge partition mode.

A geometric merge mode may be supported with 32 angles and 5 distances. The angle φᵢ may be quantized from between 0 and 360 degrees with a step equal to 11.25 degrees. In total, there may be 32 angles available for GEO. FIG. 5 depicts an example geometric split description. The description of a geometric split with angle φᵢ and distance ρᵢ is depicted in FIG. 5.

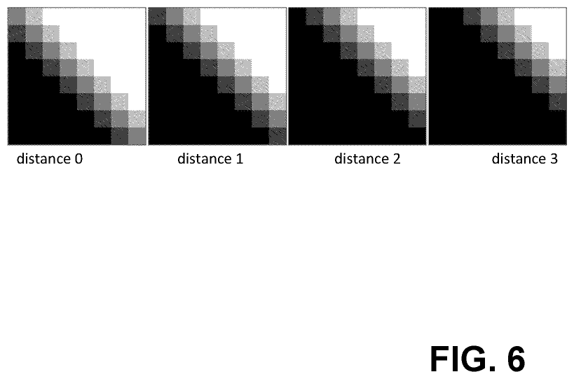

Distance ρᵢ may be quantized from the largest possible distance βₘₐₓ with a fixed step and may indicate a distance from the center of the block. For distance ρᵢ=0, the first half, e.g., only the first half, of the angles may be available as splits may be symmetric in this case. FIG. 6 depicts an example geometric partition. The results of geometric partitioning using angle 12 and distance between 0 and 3 is depicted in FIG. 6.

For a distance ρᵢ equal to 0, symmetrical angles 16 to 31 may be removed because they may correspond to the same splits as 0-15. Angles 0 and 8 may also be excluded because they are similar to binary split of CUs, leaving 14 angles, e.g., only 14 angles, for distance 0. A maximum of 142 split modes may be used by geometric partitioning (14+32*4=142).

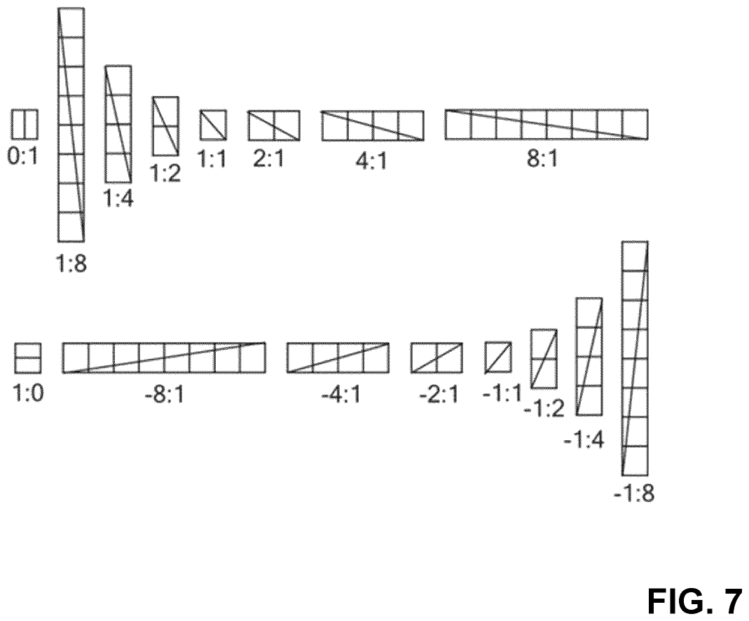

To simplify the GEO partitioning process, the angles in GEO may be replaced with the angles which have powers of 2 as tangent. Since the tangent of the proposed angles is a power-of-2 number, multiplications, e.g., most multiplications, may be replaced by bit-shifting. FIG. 7 depicts example angles proposed for GEO with their corresponding width to heigh (width:height) ratio. As depicted in FIG. 7, with the proposed angles, one row or column may be needed to store per block size and per partition mode.

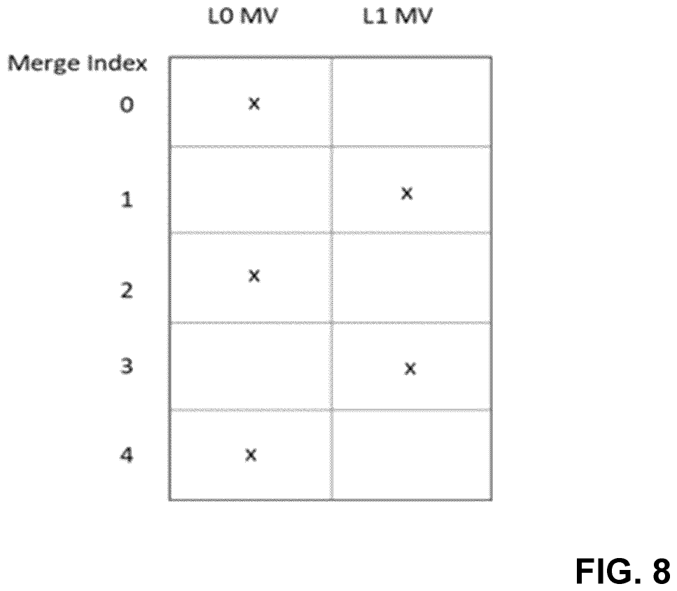

Uni-prediction candidate list construction for GEO may be provided. The GEO uni-prediction candidate list may be derived, e.g., derived directly, from the merge candidate list constructed according to the extended merge prediction process. “n” may be denoted as the index of the uni-prediction motion in the GEO uni-prediction candidate list. The LX motion vector of the n-th extended merge candidate, with X equal to the parity of n, may be used as the n-th uni-prediction motion vector for GEO partition mode. FIG. 8 depicts an example uni-prediction MV selection for GEO partition mode. These motion vectors may be marked with “x” in FIG. 8. In case a corresponding LX motion vector of the n-th extended merge candidate does not exist, the L(1-X) motion vector of the same candidate may be used instead as the uni-prediction motion vector for GEO partition mode. There may be up to 5 uni-prediction candidates and an encoder may have to test all the combinations of candidates (one for each partition) with the splitting directions and offsets.

Blending along the geometric partitioning edge may be provided. After predicting each part of a geometric partition using its own motion, blending may be applied to the two prediction signals to derive samples around a geometric partition edge. The blending weight for each position of the CU may be derived based on the distance between an individual position and the partition edge depending on the angle φᵢ and distance ρᵢ as depicted in FIG. 5.

Motion field storage for geometric partitioning mode may be provided. Mv1 from the first part of the geometric partition, Mv2 from the second part of the geometric partition, and a combined Mv of Mv1 and Mv2 may be stored in the motion field of a geometric partitioning mode coded CU.

If the motion field may be part of partition 0 (e.g., the white part of FIG. 5) or 1 (e.g., black part of FIG. 5), Mv1 or Mv2 may be stored in the corresponding motion field. If the motion field may belong to the blended part (e.g., the grey part of FIG. 5), a combined Mv from Mv1 and Mv2 may be stored. The combined Mv may be generated using the following process. If Mv1 and Mv2 may be from different reference picture lists (e.g., one from L0 and the other from L1), then Mv1 and Mv2 may be combined to form the bi-prediction motion vectors. If Mv1 and Mv2 may be from the same list, uni-prediction motion Mv2, e.g., only uni-prediction motion Mv2, may be stored.

Geometric partitioning mode (GPM) with merge motion vector differences (MMVD) may be provided. GPM in VVC may be extended by applying motion vector refinement on top of the existing GPM uni-directional MVs. A flag may be first signaled for a GPM CU to specify whether this mode may be used. If the mode may be used, each geometric partition of a GPM CU may further decide whether to signal MVD. If MVD may be signaled for a geometric partition, after a GPM merge candidate may be selected, the motion of the partition may be further refined by the signaled MVDs information. All other procedures may be kept the same as in GPM.

The MVD may be signaled as a pair of distance and direction, similar to as in MMVD. There may be nine candidate distances (¼-pel, ½-pel, 1-pel, 2-pel, 3-pel, 4-pel, 6-pel, 8-pel, 16-pel), and eight candidate directions (four horizontal/vertical directions and four diagonal directions) involved in GPM with MMVD (GPM-MMVD). If pic_fpel_mmvd_enabled_flag may be equal to 1, the MVD may be left shifted by 2 as in MMVD.

Geometric partitioning mode (GPM) with template matching (TM) may be provided. Template matching may be applied to GPM. If GPM mode may be enabled for a CU, a CU-level flag may be signaled to indicate whether the TM may be applied to both geometric partitions. Motion information for each geometric partition may be refined using TM. Table 1 presents data associated with example template matching. For each of the noted partition angles, selected templates are shown for the 1st and 2nd geometric partitions, where A indicates using above samples, L indicates using left samples, and L+A indicates using both left and above samples. If TM may be chosen, a template may be constructed using left, above, or left and above neighboring samples according to partition angle, as shown in Table 1. The motion may be refined by minimizing the difference between the current template and the template in the reference picture using the same search pattern of merge mode with a half-pel interpolation filter disabled.

TABLE 1

| Partition angle | 0 | 2 | 3 | 4 | 5 | 8 | 11 | 12 | 13 | 14 |
|---|---|---|---|---|---|---|---|---|---|---|
| 1st partition | A | A | A | A | L + A | L + A | L + A | L + A | A | A |
| 2nd partition | L + A | L + A | L + A | L | L | L | L | L + A | L + A | L + A |
| Partition angle | 16 | 18 | 19 | 20 | 21 | 24 | 27 | 28 | 29 | 30 |
| 1st partition | A | A | A | A | L + A | L + A | L + A | L + A | A | A |
| 2nd partition | L + A | L + A | L + A | L | L | L | L | L + A | L + A | L + A |

A GPM candidate list may be constructed.

Interleaved List-0 MV candidates and List-1 MV candidates may be derived, e.g., derived directly, from the regular merge candidate list, where List-0 MV candidates may be higher priority than List-1 MV candidates. A pruning method with an adaptive threshold based on the current CU size may be applied to remove redundant MV candidates.

Interleaved List-1 MV candidates and List-0 MV candidates may be further derived, e.g., derived directly, from the regular merge candidate list, where List-1 MV candidates may be higher priority than List-0 MV candidates. The same pruning method with the adaptive threshold may also be applied to remove redundant MV candidates.

Zero MV candidates may be padded until the GPM candidate list is full.

The GPM-MMVD and GPM-TM may be enabled, e.g., exclusively enabled, to one GPM CU. This may be done by firstly signaling the GPM-MMVD syntax. If both of two GPM-MMVD control flags may be equal to false (e.g., the GPM-MMVD may be disabled for two GPM partitions), the GPM-TM flag may be signaled to indicate whether the template matching may be applied to the two GPM partitions. Otherwise (e.g., at least one GPM-MMVD flag may be equal to true), the value of the GPM-TM flag may be inferred to be false.

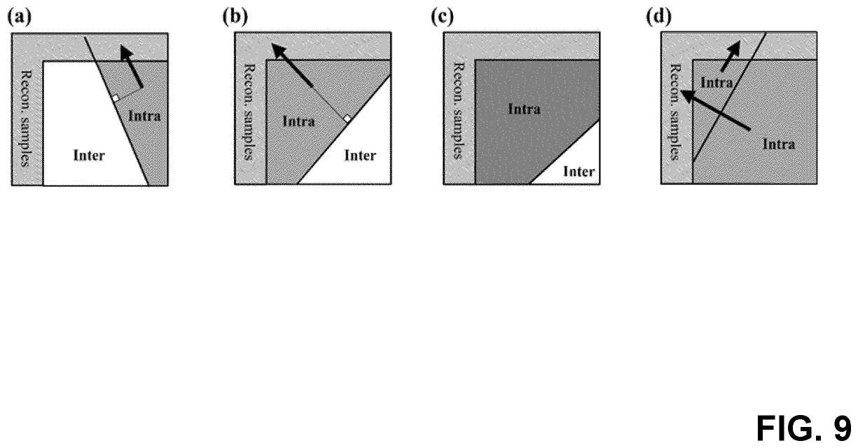

In GPM with inter and intra prediction, the final prediction samples may be generated by weighting inter predicted samples and intra predicted samples for each GPM-separated region. The inter predicted samples may be derived by inter GPM, whereas the intra predicted samples may be derived by an intra prediction mode (IPM) candidate list and an index signaled from the encoder. The IPM candidate list size may be pre-defined as 3. FIG. 9 depicts example GPM with inter and intra prediction. Available IPM candidates are depicted at (a) trough (c), while (d) depicts an example of GPM with intra and intra prediction. The available IPM candidates may be the parallel angular mode against the GPM block boundary (Parallel mode), the perpendicular angular mode against the GPM block boundary (Perpendicular mode), and the Planar mode as shown in FIG. 9 at (a), (b), and (c), respectively. GPM with intra and intra prediction as shown in FIG. 9 at (d) may be restricted to reduce the signalling overhead for IPMs and may avoid an increase in the size of the intra prediction circuit on the hardware decoder. In addition, a direct motion vector and IPM storage on the GPM-blending area may be introduced to further improve the coding performance.

In DIMD and neighboring mode based IPM derivation, Parallel mode may be registered first. Therefore, max two IPM candidates derived from the decoder-side intra mode derivation (DIMD) method and/or the neighboring blocks may be registered if the same IPM candidate may not be in the list. Table 2 depicts the position of available neighboring blocks for IPM candidate derivation based on the angle of GPM block boundary. In Table 2, A and L may denote the above and left side of the prediction block. As for the neighboring mode derivation, there may be five positions, e.g., five positions at most, for available neighboring blocks, but they may be restricted by the angle of GPM block boundary as shown in Table 2, which may have already been used for GPM with template matching (GPM-TM).

TABLE 2

| Angle of GPM | 0 | 2 | 3 | 4 | 5 | 8 | 11 | 12 | 13 | 14 |
|---|---|---|---|---|---|---|---|---|---|---|
| 1st partition | A | A | A | A | L + A | L + A | L + A | L + A | A | A |
| 2nd partition | L + A | L + A | L + A | L | L | L | L | L + A | L + A | L + A |
| Partition angle | 16 | 18 | 19 | 20 | 21 | 24 | 27 | 28 | 29 | 30 |
| 1st partition | A | A | A | A | L + A | L + A | L + A | L + A | A | A |
| 2nd partition | L + A | L + A | L + A | L | L | L | L | L + A | L + A | L + A |

GPM-intra may be combined with GPM with merge with motion vector difference (GPM-MMVD). TIMD may be used for IPM candidates of GPM-intra to further improve the coding performance. The Parallel mode may be registered first, then IPM candidates of TIMD, DIMD, and neighboring blocks.

Template matching based reordering for GPM split modes my be provided. In template matching based reordering for GPM split modes, given the motion information of the current GPM block, the respective TM cost values of GPM split modes may be computed. GPM split modes, e.g., all GPM split modes, may then be reordered in ascending ordering based on the TM cost values. Instead of sending GPM split mode, an index using Golomb-Rice code to indicate where the exact GPM split mode may be in the reordering list may be signaled.

The reordering method for GPM split modes may be a process, e.g., a two-step process, performed after the respective reference templates of the two GPM partitions in a coding unit may be generated. A GPM partition edge may be extended into the reference templates of the two GPM partitions, resulting in 64 reference templates and the respective TM cost may be computed for each of the 64 reference templates. Then the GPM split modes may be reordered based on their TM cost values in ascending order and the best 32 may be identified, e.g., marked, as available split modes.

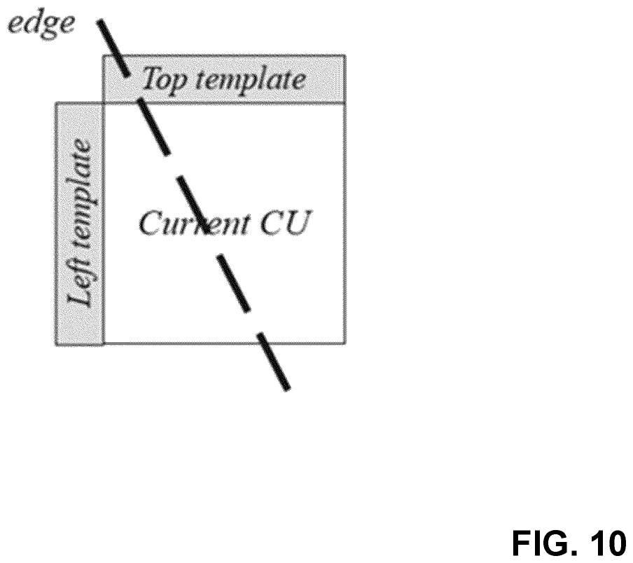

FIG. 10 depicts an example edge on a template. The edge on the template may be extended from that of the current CU, as depicted in FIG. 10, but the GPM blending process may not be used in the template area across the edge.

After ascending reordering using TM cost, an index may be signaled.

Multiple Hypothesis Prediction (MHP) may be provided. In the multi-hypothesis inter prediction mode, one or more additional motion-compensated prediction signals may be signaled, in addition to the bi prediction signal, e.g., conventional bi prediction signal. The resulting overall prediction signal may be obtained by sample-wise weighted superposition. With the bi prediction signal p_{bi} and the first additional inter prediction signal/hypothesis h₃, the resulting prediction signal p₃ may be obtained as follows: p₃=(1−a) p_{bi}+ah₃. The weighting factor α may be specified by the syntax element add_hyp_weight_idx, according to the mapping shown in Table 3.

TABLE 3

| add_hyp_weight_idx | α |
|---|---|
| 0 | ¼ |
| 1 | −⅛ |

Analogously to above, more than one additional prediction signal may be used. The resulting overall prediction signal may be accumulated iteratively with each additional prediction signal. A prediction signal may be represented as follows: Pₙ₊₁=(1−aₙ₊₁)pₙ+aₙ₊₁ hₙ₊₁. The resulting overall prediction signal may be obtained as the last pₙ (e.g., the pₙ having the largest index n). In current CTC, the configuration file sets AdditionalInterHyps may be equal to 2, which means up to two additional prediction signals may be used (e.g., n may be limited to 2).

The motion parameters of each additional prediction hypothesis may be signaled either explicitly by specifying the reference index, the motion vector predictor index, and the motion vector difference, or implicitly by specifying a merge index. A separate multi-hypothesis merge flag may distinguish between these two signalling modes.

For inter AMVP mode, MHP may be, e.g., may only be, applied if non-equal weight in BCW may be selected in bi-prediction mode. Combination of MHP and BDOF may be possible, however the BDOF may be applied, e.g., may only be applied, to the bi-prediction signal part of the prediction signal (e.g., the ordinary first two hypotheses).

Multi-Pass Decoder Side Motion Motion-Vector Refinement (DMVR) may be provided. A multi-pass decoder-side motion vector refinement may be applied. In the first pass, bilateral matching (BM) may be applied to the coding block. In the second pass, BM may be applied to each 16×16 subblock within the coding block. In the third pass, MV in each 8×8 subblock may be refined by applying bi-directional optical flow (BDOF). The refined MVs may be stored for spatial and/or temporal motion vector prediction.

A first pass of block based bilateral matching MV refinement may be provided. In the first pass, a refined MV may be derived by applying BM to a coding block. Similar to decoder-side motion vector refinement (DMVR), in bi-prediction operation, a refined MV may be searched around the two initial MVs (MV0 and MV1) in the reference picture lists L0 and L1. The refined MVs (MV0_pass1 and MV1_pass1) may be derived around the initiate MVs based on the minimum bilateral matching cost between the two reference blocks in L0 and L1.

BM may perform a local search to derive integer sample precision intDeltaMV. The local search may apply a 3×3 square search pattern to loop through the search range [−sHor, sHor] in horizontal direction and [−sVer, sVer] in vertical direction, wherein, the values of sHor and sVer may be determined by the block dimension, and the maximum value of sHor and sVer may be 8.

The bilateral matching cost may be calculated as follows: bilCost=mvDistanceCost+sadCost. If the block size cbW*cbH may be greater than 64, a mean-removal SAD (MRSAD) cost function may be applied to remove the DC effect of distortion between reference blocks. If the bilCost at the center point of the 3×3 search pattern has the minimum cost, the intDeltaMV local search may be terminated. Otherwise, the current minimum cost search point may become the new center point of the 3×3 search pattern and may continue to search for the minimum cost, until it may reach the end of the search range.

The existing fractional sample refinement may be further applied to derive the final deltaMV. The refined MVs after the first pass may be derived as follows: MV0_pass1=MV0+deltaMV; MV1_pass1=MV1-deltaMV.

A second pass of subblock based bilateral matching MV refinement may be provided. In the second pass, a refined MV may be derived by applying BM to a 16×16 grid subblock. For each subblock, a refined MV may be searched around the two MVs (MV0_pass1 and MV1_pass1), obtained on the first pass, in the reference picture list L0 and L1. The refined MVs (MV0_pass2 (sbldx2) and MV1_pass2 (sbldx2) may be derived based on the minimum bilateral matching cost between the two reference subblocks in L0 and L1.

For each subblock, BM may perform full search to derive integer sample precision intDeltaMV. The full search may have a search range [−sHor, sHor] in horizontal direction and [−sVer, sVer] in vertical direction, wherein, the values of sHor and sVer may be determined by the block dimension, and the maximum value of sHor and sVer may be 8.

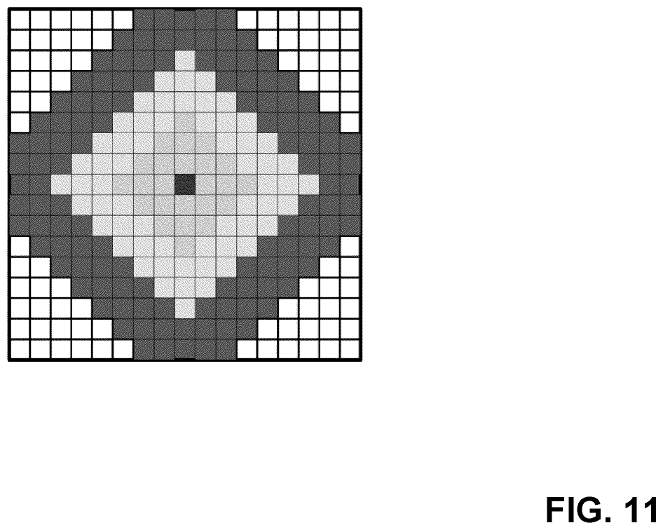

The bilateral matching cost may be calculated by applying a cost factor to the SATD cost between two reference subblocks as follows: bilCost=satdCost*costFactor. The search area, (2*sHor+1)*(2*sVer+1), may be divided into 5 diamond shape search regions. FIG. 11 depicts an example of diamond regions in the search area. Each search region may be assigned a costFactor, which may be determined by the distance (intDeltaMV) between each search point and the starting MV, and each diamond region may be processed in the order starting from the center of the search area. In each region, the search points may be processed in the raster scan order starting from the top left going to the bottom right corner of the region. If the minimum bilCost within the current search region may be less than a threshold equal to sbW*sbH, the int-pel full search may be terminated. Otherwise, the int-pel full search may continue to the next search region until all search points are examined. If the difference between the previous minimum cost and the current minimum cost in the iteration may be less than a threshold that may be equal to the area of the block, the search process may terminate.

The existing VVC DMVR fractional sample refinement may be further applied to derive the final deltaMV (sbldx2). The refined MVs at second pass may then be derived as follows: MV0_pass2 (sbldx2)=MV0_pass1+deltaMV (sbldx2); MV1_pass2 (sbldx2)=MV1_pass1-deltaMV (sbldx2).

A third pass of subblock based bi-directional optical flow MV refinement may be provided. In the third pass, a refined MV may be derived by applying BDOF to an 8×8 grid subblock. For each 8×8 subblock, BDOF refinement may be applied to derive scaled Vx and Vy without clipping starting from the refined MV of the parent subblock of the second pass. The derived bioMv (Vx, Vy) may be rounded to 1/16 sample precision and may be clipped between −32 and 32.

The refined MVs (MV0_pass3 (sbldx3) and MV1_pass3 (sbldx3) at third pass may be derived as follows: MV0_pass3 (sbldx3)=MV0_pass2 (sbldx2)+bioMv; MV1_pass3 (sbldx3)=MV0_pass2 (sbldx2)-bioMv.

In all sub-clauses mentioned herein, if wrap around motion compensation may be enabled, the motion vectors may be clipped with wrap around offset taken into consideration.

Adaptive decoder-side motion vector refinement may be provided. Adaptive decoder side motion vector refinement method may be an extension of multi-pass DMVR which may consist of the two new merge modes to refine MV only in one direction, either L0 or L1, of the bi prediction for the merge candidates that meet the DMVR conditions. The multi-pass DMVR process may be applied for the selected merge candidate to refine the motion vectors, however either MVD0 or MVD1 may be set to zero in the first pass (e.g., PU level) DMVR.

The merge candidates for the new merge mode may be derived from spatial neighboring coded blocks, TMVPs, non-adjacent blocks, HMVPs, pair-wise candidate, similarly to as in the regular merge mode. The difference may be that those that meet, e.g., only those that meet, DMVR conditions may be added into the candidate list. The same merge candidate list may be used by the two new merge modes. If the list of BM candidates contains the inherited BCW weights, the DMVR process may be unchanged except the computation of the distortion may be made using MRSAD or MRSATD if the weights may be non-equal and the bi-prediction may be weighted with BCW weights. Merge index may be coded as in regular merge mode.

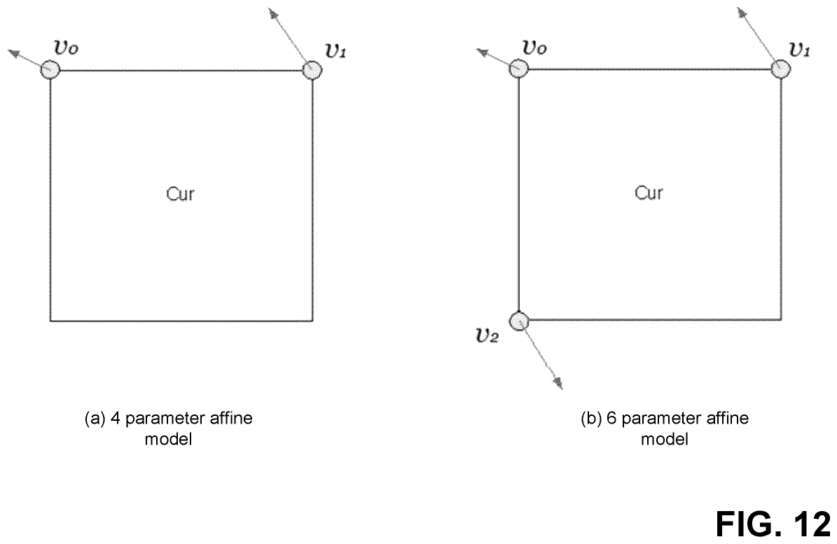

Affine motion compensated prediction may be provided. In HEVC, translation motion model, e.g., only translation motion model, may be applied for motion compensation prediction (MCP). There are many kinds of motion such as for example, zoom in/out, rotation, perspective motions, and the other irregular motions. In WVC, a block-based affine transform motion compensation prediction may be applied. FIG. 12 depicts an example control point based affine motion model. As shown in FIG. 12, the affine motion field of the block may be described by motion information of two control point (4-parameter affine model noted in section (a)) or three control point motion vectors (6-parameter affine mode noted in section (b)).

For 4-parameter affine motion model, motion vector at sample location (x, y) in a block may be derived using equations (1) and (2) as follows:

$$\{ \begin{matrix}m {v}_{x} = \frac{m {v}_{1 x} - m {v}_{0 x}}{W} x + \frac{m {v}_{1 y} - m {v}_{0 y}}{W} y + m {v}_{0 x} \\ m {v}_{y} = \frac{m {v}_{1 y} - m {v}_{0 y}}{W} x + \frac{m {v}_{1 x} - m {v}_{0 x}}{W} y + m {v}_{0 y}\end{matrix} \qquad ( 1 )$$

For 6-parameter affine motion model, motion vector at sample location (x, y) in a block may be derived as:

$$\{ \begin{matrix}m {v}_{x} = \frac{m {v}_{1 x} - m {v}_{0 x}}{W} x + \frac{m {v}_{2 x} - m {v}_{0 x}}{W} y + m {v}_{0 x} \\ m {v}_{y} = \frac{m {v}_{1 y} - m {v}_{0 y}}{W} x + \frac{m {v}_{2 y} - m {v}_{0 y}}{W} y + m {v}_{0 y}\end{matrix} \qquad ( 2 )$$

where (mv₀ₓ, mv_{0y}) may be a motion vector of the top-left corner control point, (mv₁ₓ, mv_{1y}) may be a motion vector of the top-right corner control point, and (mv₂ₓ, mv_{2y}) may be a motion vector of the bottom-left corner control point and (0,0) may be the top-left sample of the block.

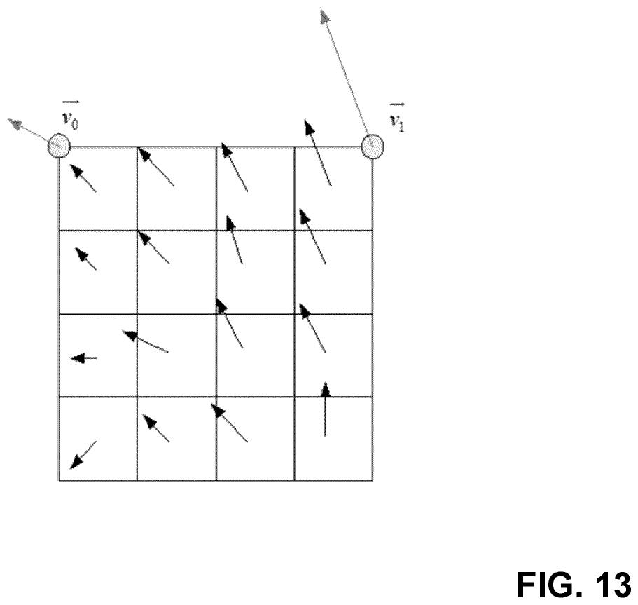

To simplify the motion compensation prediction, block based affine transform prediction may be applied. FIG. 13 depicts example affine MVF per subblock. To derive a motion vector of each 4×4 luma subblock, the motion vector of the center sample of each subblock, as shown in FIG. 13, may be calculated according to the above equations, and may be rounded to 1/16 fraction accuracy. The motion compensation interpolation filters may be applied to generate the prediction of each subblock with derived motion vector. The subblock size of chroma-components may also be set to 4×4. The MV of a 4×4 chroma subblock may be calculated as the average of the MVs of the top-left and bottom-right luma subblocks in the collocated 8×8 luma region.

As may be performed for translational motion inter prediction, there may also be two affine motion inter prediction modes: affine merge mode and affine AMVP mode.

The following modes may not have been compatible with GPM although they may provide coding improvements: bi-prediction; Multiple Hypothesis Prediction (MHP); Decoder Side Motion Refinement (DMVR); and affine merge mode.

Disclosed herein are examples for combining GPM with the following modes: Bi-prediction on each GPM partition; DMVR with GPM; MHP in combination with GPM; and Affine merge mode in combination with GPM.

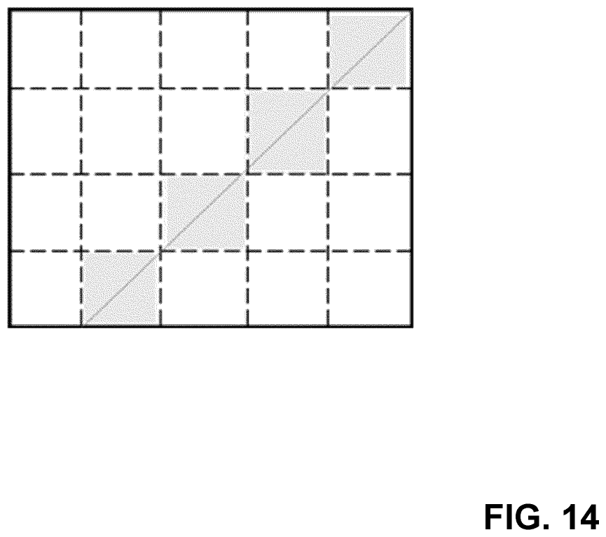

FIG. 14 depicts an example GPM split boundary between two GPM partitions. In FIG. 14, an example GPM coded CU is depicted with the split and the subblocks containing the split in grey. The top part (a first GPU partition) and bottom part (a second GPU partition) of the CU may use two different motion compensated or intra predictions.

Examples are disclosed for employing bi-directional prediction in Geometric Partition Mode. A device, which may be, for example, an encoder, may determine for a coding unit a first geometric partitioning mode (GPM) partition and a second GPM partition. A first prediction mode may be associated with the first GPM partition and a second prediction mode may be associated with the second GPM partition. For example, the first GPM partition may employ inter prediction and the second GPM partition may employ intra prediction. The device may determine bi-directional motion vectors for at least one of the first GPM partition and the second GPM partition. Bi-directional motion vectors may be determined for both GPM partitions or only one of the GPM partitions. The device may determine for each of the first GPM partition and the second GPM partition, a flag that indicates whether bi-directional motion vectors have been determined for the particular one of the GPM partitions. The device may encode the coding unit including the at least one of the first GPM partition and the second GPM partition based on the determined bi-directional motion vectors. The flags may be encoded and communicated with the encoded coding unit to the decoder. The decoder may use the flags to implement bi-directional prediction in Geometric Partition Mode.

Bi-directional, which may be referred to as bi-dir, motion vectors used with GPM may be provided. To improve the quality of the prediction performed by GPM, bi-directional motion vectors may be used on each sub-partition, e.g., a first GPM partition and a second GPM partition. This may lead to using up to 4 Mvs on the block.

Instead of constructing a uni-prediction candidate list from the extended candidate list, the extended merge candidate list may be used as—is for the GPM candidate list.

The encoder may signal which list may be used with two uni_gpm_predictionX flags, with X being either 0 or 1 denoting which of partitions, 0 or 1, to which the flag applies. If the flag is 1, the ECM-7.0 uni-prediction candidate list for GPM may be used on partition X. If the flag is 0, the extended merge list may be used, and bi-directional motion vectors may be allowed. In an embodiment, one flag, e.g., only one flag, may be used so that both partitions may use the same list.

Bi-direction GPM may be allowed, e.g., may only be allowed, on one partition and if the other partition is using intra GPM, so that there may be no more than two motion vectors, MVs, on the block.

Bi-direction GPM use may be tied to AdditionalInterHyps, which may be discussed herein, so that the number of inter-predictions used by GPM may be no more than the value of AdditionalInterHyps plus two (AdditionalInterHyps+2).

Examples are disclosed for employing Decoder Side Motion Refinement (DMVR) in Geometric Partition Mode. A device, which may be, for example, a decoder, may determine for a coding unit a first geometric partitioning mode (GPM) partition, a second GPM partition, and a third GPM partition. The third GPM partition may be positioned between the first GPM partition and the second GPM partition. A first prediction mode may be associated with the first GPM partition and a second prediction mode may be associated with the second GPM partition. For example, the first GPM partition may employ inter prediction and the second GPM partition may employ intra prediction. The device may apply bilateral matching (BM) to at least one of the first GPM partition, the second GPM partition, and the third GPM partition to refine a motion vector. The device may decode the at least one of the first GPM partition, the second GPM partition, and the third GPM partition based on the refined motion vector. The device may apply bilateral matching to each of the first, second, and third GPM partitions and may decode the first, second, and third GPM partitions based on the motion vector. The device may apply bilateral matching to the third GPM partition and may decode the first, second, and third GPM partitions based on the motion vector. The device may apply bilateral matching to the third GPM partition and may decode the third GPM partition, e.g., only the third GPM partition, based on the motion vector.

GPM used with DMVR may be provided. To improve the quality of the prediction of GPM, multi-pass decoder side vector refinement may be provided on top of GPM.

The bilateral matching (BM) may be applied on an entire block using the GPM weights on the entire partition.

The bilateral matching (BM) may be performed, e.g., may only be performed, on the blended area (e.g., the grey area represented in FIG. 14), which may be referred to as a third partition, and may be performed, e.g., may only be performed, if the two GPM partitions are uni. The refined motion vector for the whole partitions may be used to perform the motion compensation. In an example, a sub-block, e.g., only sub-block, in the grey area may use the refined motion vectors.

If bi-directional GPM may be allowed, DMVR may be applied on each sub-partition, and the bilateral matching (BM) may be performed, e.g., may only be performed, on the non-grey area, separately for each partition.

Examples are disclosed for employing Multiple Hypothesis Prediction (MHP) in Geometric Partition Mode. A device, which may be, for example, an encoder, may determine for a coding unit a first geometric partitioning mode (GPM) partition and a second GPM partition. A first prediction mode may be associated with the first GPM partition and a second prediction mode may be associated with the second GPM partition. For example, the first GPM partition may employ inter prediction and the second GPM partition may employ intra prediction. The device may determine a directional prediction signal and may determine at least one additional motion-compensated prediction signal associated with multi-hypothesis prediction (MHP). If the first prediction method is bi-directional prediction and the second prediction method is uni-directional prediction, the device may determine one additional motion-compensated prediction signal. If the first prediction method is uni-directional and the second prediction method is uni-directional, the device may determine two additional motion-compensated prediction signals. If the first prediction method is uni-directional prediction and the second prediction method is intra prediction, the device may determine two additional motion-compensated prediction signals. The device may encode the coding unit using the at least the motion-compensated prediction signal and may send encoded coding unit and the at least one additional motion-compensated prediction signal to the decoder.

MHP used with GPM may be provided. MHP used with GPM may result in improved prediction.

MHP used with GPM may not be allowed in combination with bi-directional GPM to not increase the worst-case number of inter predictions performed in a block. For example, it may be desired to not have, e.g., never have, more than 4 Mvs used on a block for the current CTC where AdditionalInterHyps is equal to two. Therefore, if a block using GPM has one GPM partition using a bi-directional prediction and the other using a uni prediction, the value of AdditionalInterHpys minus one, e.g., AdditionalInterHyps-1, may be allowed for the block. If one partition uses bi-prediction and the other is intra, or if both partitions are uni, up to the value of AdditionalInterHyps of additional hypothesis may be allowed. If both GPM partitions use bi-directional Mvs, up to the value of AdditionalInterHyps minus two, e.g., AdditionalInterHyps-2, may be allowed on the block.

Examples are disclosed for employing affine merge mode in Geometric Partition Mode. A device, which may be, for example, an encoder, may determine for a coding unit a first geometric partitioning mode (GPM) partition and a second GPM partition. The device may determine for the first GPM partition a first motion vector using affine transform motion compensation prediction. The device may determine for the second GPM partition a second motion vector using affine transform motion compensation. The device may determine a first set of control points associated with the first GPM partition and may determine a second set of control points associated with the second GPM partition. The device may determine the first motion vector using affine transform motion compensation prediction and the second motion vector using affine transform motion compensation based on the first set of control points and the second set of control points. The device may encode the coding unit using the first motion vector and the second motion vector. Affine merge motion vector prediction used with GPM may be provided.

In examples, the control points that may be used may differ for each partition. Partition 0 may use control points v0 and v1 and partition 2 may use control points v0 and v2 for 4-parameters affine model. The motion vector at sample location (x, y) in a block may then be derived using equations (3) and (4) as follows:

$$\{ \begin{matrix}m {v}_{x} = \frac{m {v}_{1 x} - m {v}_{0 x}}{W} x + \frac{m {v}_{1 y} - m {v}_{0 y}}{W} y + m {v}_{0 x} \\ m {v}_{y} = \frac{m {v}_{1 y} - m {v}_{0 y}}{W} x + \frac{m {v}_{1 x} - m {v}_{0 x}}{W} y + m {v}_{0 y}\end{matrix} \qquad ( 3 )$$

for partition 0, and

$$\{ \begin{matrix}m {v}_{x} = \frac{m {v}_{2 x} - m {v}_{0 x}}{W} x + \frac{m {v}_{2 y} - m {v}_{0 y}}{W} y + m {v}_{0 x} \\ m {v}_{y} = \frac{m {v}_{2 y} - m {v}_{0 y}}{W} x + \frac{m {v}_{2 x} - m {v}_{0 x}}{W} y + m {v}_{0 y}\end{matrix} \qquad ( 4 )$$

for partition 1.

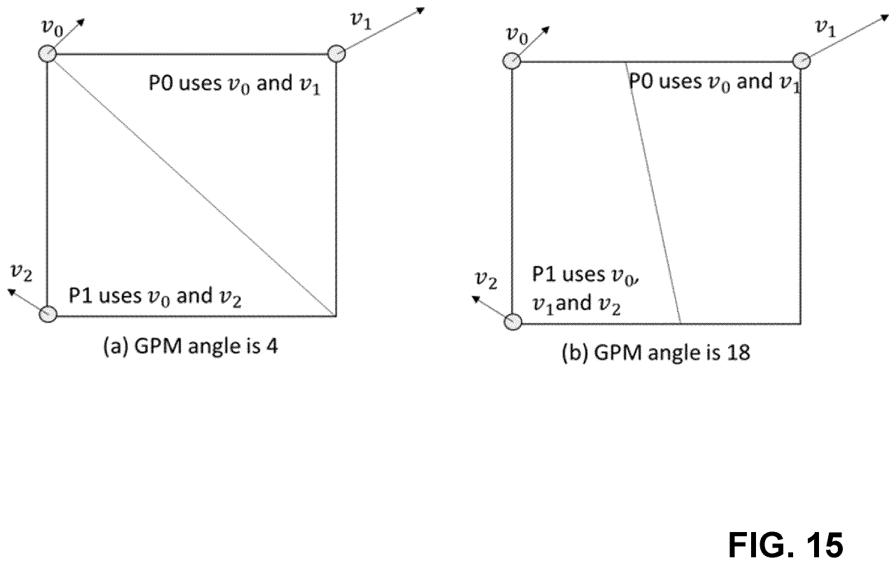

For a six-parameter affine model, the control points that may be used may depend on the partition angle. Table 4 indicates control points that may be used for a six-parameter affine model in GPM, depending on the partition and the GPM angle. FIG. 15 depicts example control points that may be used depending on the partition angle for angles 4 and 18. For example, the control points that may be used may be as described in Table 4 and may be as exemplified in FIG. 15.

TABLE 4

| Angle of GPM | 0 | 2 | 3 | 4 | 5 | 8 | 11 | 12 | 13 | 14 |
|---|---|---|---|---|---|---|---|---|---|---|
| Partition 0 | v0, | v0, | v0, | v0, | v0, | v0, | v0, | v0, | v0, | v0, |
| | v1 | v1 | v1 | v1 | v1, | v1, | v1, | v1, | v1 | v1 |
| | | | | | v2 | v2 | v2 | v2 | | |
| Partition 1 | v0, | v0, | v0, | v0, | v0, | v0, | v0, | v0, | v0, | v0, |
| | v1, | v1, | v1, | v2 | v2 | v2 | v2 | v1, | v1, | v1, |
| | v2 | v2 | v2 | | | | | v2 | v2 | v2 |
| Partition angle | 16 | 18 | 19 | 20 | 21 | 24 | 27 | 28 | 29 | 30 |
| Partition 0 | v0, | v0, | v0, | v0, | v0, | v0, | v0, | v0, | v0, | v0, |
| | v1 | v1 | v1 | v1 | v1, | v1, | v1, | v1, | v1 | v1 |
| | | | | | v2 | v2 | v2 | v2 | | |
| Partition 1 | v0, | v0, | v0, | v0, | v0, | v0, | v0, | v0, | v0, | v0, |
| | v1, | v1, | v1, | v2 | v2 | v2 | v2 | v1, | v1, | v1, |
| | v2 | v2 | v2 | | | | | v2 | v2 | v2 |

Two separate flags may be used to indicate if each GPM partition may use affine.

In examples, the partitions may use independent control point motion vectors. The affine motion model may be inferred separately for each partition and the usual GPM process may be applied. The inherited affine motion model or reconstructed affine motion model may use candidate motion vectors dependent on the partition angle.

In examples, affine merge motion vector prediction in GPM may employ bidirectional prediction using bidirectional motion vectors. In examples, the affine prediction candidate list may use the GPM candidate list. The affine prediction candidate list that is used for GPM may reuse the same candidate list as regular affine (e.g., the same as when affine is not combined with GPM). If affine is applied with GPM using bi-prediction, each GPM partition may use a weighted averaging prediction by combining two affine predictions, wherein each affine prediction may be generated separately from its respective reference list. Each prediction may be made according to the affine equations such as, for example, equations (3) and (4) described herein, depending on the partition. The two predictions may be averaged to produce the final prediction for the partition. In examples, to limit processing time, one, e.g., only one, of the two bi-dir GPM partitions may use bi-predicational affine. In examples, restrictions on bi-dir GPM used in combination with affine bi-dir may be made depending on block size, QP, and/or sequence configurations.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1-53. (canceled)

54. A device for video decoding, comprising:
a processor configured to:
determine, for a coding block, a first geometric partitioning mode (GPM) partition and a second GPM partition;
obtain, for the coding block, a motion information merge candidate list that comprises at least one bi-prediction motion information;
determine for the first GPM partition, based on the motion information merge candidate list, first bi-predicted motion information, the first bi-predicted motion information comprising a first motion vector and a second motion vector; and
predict the first GPM partition based on the first bi-prediction motion information comprising the first motion vector and the second motion vector.

55. The device for video decoding of claim 54,
wherein the processor is further configured to:
determine for the second GPM partition, based on the motion information merge candidate list, second bi-predicted motion information, the second bi-predicted motion information comprising a third motion vector and a fourth motion vector; and
predict the second GPM partition based on the second bi-prediction motion information comprising the third motion vector and the fourth motion vector.

56. The device for video decoding of claim 54,
wherein the motion information merge candidate list comprises an extended merge candidate list.

57. The device for video decoding of claim 54,
wherein the processor is further configured to:
obtain, for the coding block, a uni-prediction candidate list;
determine, for the second GPM partition, uni-predicted motion information, based on the uni-prediction candidate list; and
predict the second GPM partition based on the uni-predicted motion information.

58. The device for video decoding of claim 54,
wherein the processor is further configured to:
predict the second GPM partition using intra-prediction.

59. The device for video decoding of claim 54,
wherein the processor is further configured to:
determine, for a second coding block, a third GPM partition and a fourth GPM partition;
obtain, for the third GPM partition, a first affine motion model that uses a uni-prediction candidate as Control Point Motion Vector; and
perform affine motion compensation prediction on the third GPM partition based on the first affine motion model.

60. The device for video decoding of claim 59,
wherein the processor configured to perform affine motion compensation prediction on the third GPM partition is further configured to determine a first set of control points associated with the first GPM partition and determine a first set of motion vectors using affine motion compensation prediction based on at least the first set of control points.

61. The device for video decoding of claim 55,
wherein the processor configured to determine for the first GPM partition, the first bi-predicted motion information is further configured to determine the first bi-predicted motion information using multiple hypothesis prediction (MHP); and
wherein the processor configured to determine for the second GPM partition, the second bi-predicted motion information is further configured to determine the second bi-predicted motion information using MHP.

62. The device for video decoding of claim 54,
wherein the processor configured to determine for the first GPM partition, the first bi-predicted motion information is further configured to refine the first bi-predicted motion information using decoder side motion vector refinement (DMVR)

63. A method of video decoding, comprising:
determining, for a coding block, a first geometric partitioning mode (GPM) partition and a second GPM partition;
obtaining, for the coding block, a motion information merge candidate list that comprises at least one bi-prediction motion information;
determining for the first GPM partition, based on the motion information merge candidate list, first bi-predicted motion information, the first bi-predicted motion information comprising a first motion vector and a second motion vector; and
predicting the first GPM partition based on the first bi-prediction motion information comprising the first motion vector and the second motion vector.

64. The method of claim 63, further comprising:
determining for the second GPM partition, based on the motion information merge candidate list, second bi-predicted motion information, the second bi-predicted motion information comprising a third motion vector and a fourth motion vector; and
predicting the second GPM partition based on the second bi-prediction motion information comprising the third motion vector and the fourth motion vector.

65. A device for video encoding, comprising:
a processor configured to:
determine, for a coding block, a first geometric partitioning mode (GPM) partition and a second GPM partition;
obtain, for the coding block, a motion information merge candidate list that comprises at least one bi-prediction motion information;
determine for the first GPM partition, based on the motion information merge candidate list, first bi-predicted motion information, the first bi-predicted motion information comprising a first motion vector and a second motion vector;
predict the first GPM partition based on the first bi-prediction motion information comprising the first motion vector and the second motion vector.

66. The device for video encoding of claim 65,
wherein the processor is further configured to:
determine for the second GPM partition, based on the motion information merge candidate list, second bi-predicted motion information, the second bi-predicted motion information comprising a third motion vector and a fourth motion vector; and
predict the second GPM partition based on the second bi-prediction motion information comprising the third motion vector and the fourth motion vector.

67. The device for video encoding of claim 65,
wherein the motion information merge candidate list comprises an extended merge candidate list.

68. The device for video encoding of claim 65,
wherein the processor is further configured to:
obtain, for the coding block, a uni-prediction candidate list;
determine, for the second GPM partition, uni-predicted motion information, based on the uni-prediction candidate list; and
predict the second GPM partition based on the uni-predicted motion information.

69. The device for video encoding of claim 65,
wherein the processor is further configured to:
predict the second GPM partition using intra-prediction.

70. The device for video encoding of claim 65,
wherein the processor is further configured to:
determine, for a second coding block, a third GPM partition and a fourth GPM partition;
obtain, for the third GPM partition, a first affine motion model that uses a uni-prediction candidate as Control Point Motion Vector; and
perform affine motion compensation prediction on the third GPM partition based on the first affine motion model.

71. The device for video encoding of claim 70,
wherein the processor configured to perform affine motion compensation prediction on the third GPM partition is further configured to determine a first set of control points associated with the first GPM partition and determine a first set of motion vectors using affine motion compensation prediction based on at least the first set of control points.

72. The device for video encoding of claim 66,
wherein the processor configured to determine for the first GPM partition, the first bi-predicted motion information is further configured to determine the first bi-predicted motion information using multiple hypothesis prediction (MHP); and
wherein the processor configured to determine for the second GPM partition, the second bi-predicted motion information is further configured to determine the second bi-predicted motion information using MHP.

73. The device for video encoding of claim 65,
wherein the processor configured to determine for the first GPM partition, the first bi-predicted motion information is further configured to refine the first bi-predicted motion information using decoder side motion vector refinement (DMVR).
